(19) United States
(12) Patent Application Publication
(10) Pub. No.: US 2010/0224826 A1
(43) Pub. Date: Sep. 9, 2010

(54) Dispersion Liquid Comprising Liquid Crystal-Compatible Particles, Paste Obtained Therefrom, and Mehtod for Preparing the Same

(76) Inventors: Shigeyoshi Nishino, Yamaguchi (JP); Shuji Yokoyama, Yamaguchi (JP); Shinya Takigawa, Yamaguchi (JP); Naoki Toshima, Yamaguchi (JP)

Correspondence Address: BIRCH STEWART KOLASCH & BIRCH, PO BOX 747, FALLS CHURCH, VA, 22040-0747, US

(21) Appl. No.: 12/223,020

(22) PCT Filed: Jan. 30, 2007
(86) PCT No.: PCT/JP2007/051428

§ 371 Date: Jul. 21, 2008

(30) Foreign Application Priority Data
Jan. 31, 2006 (JP) 2006-023494
Mar. 20, 2006 (JP) 2006-075899

(51) Int. Cl. C09K 19/52

(52) U.S. Cl. 252/299.01; 977/773

(57) ABSTRACT

A task of the present invention is to provide a method for preparing a dispersion liquid comprising liquid crystal-compatible particles and a paste thereof, which is commercially advantageous in that a dispersion liquid comprising liquid crystal-compatible particles and a uniform liquid crystal-compatible particle paste can be obtained using a method which can easily achieve mass-production.

The task of the present invention is achieved by a method for preparing a dispersion liquid comprising liquid crystal-compatible particles wherein the method comprises mixing together at least one type of liquid crystal molecules, a secondary alcohol represented by the following general formula (1):

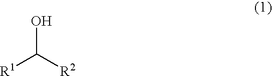

wherein R¹ and R² are the same or different and independently represent a hydrocarbon group optionally having a substituent, or R¹ and R² may be bonded together to form a ring,
   and an organic solvent, and adding to the resultant mixture a solution containing at least one type of metal ions while heating the mixture under reflux to effect a reaction.

### FIELD OF THE INVENTION

The present invention relates to a dispersion liquid comprising liquid crystal-compatible particles, a paste obtained therefrom, and a method for preparing the same. The liquid crystal-compatible particle paste is useful as an additive material for, e.g., liquid crystal display to improve the response time or lower the driving voltage for liquid crystal.

### BACKGROUND ART

As a conventional method for preparing a dispersion liquid comprising liquid crystal-compatible particles or a paste thereof, for example, a method is disclosed in which liquid crystal molecules, palladium acetate, and ethanol are placed in a Schlenk tube made of quartz and then irradiated with ultraviolet light using a high-pressure mercury lamp to obtain a dispersion liquid comprising liquid crystal-compatible palladium nanoparticles, and then the dispersion liquid obtained is concentrated to obtain a liquid crystal-compatible palladium nanoparticle paste (see, for example, patent document 1). However, this method has a problem in that dispersion is observed in the particle size distribution of the liquid crystal-compatible particles formed (precipitates are present in a small amount) (see Comparative Example 1). Further, the patent document 1 has merely a description of an example of palladium single-component nanoparticles formed by photoreduction, and has no description of other specific reduction methods or use of two or more specific types of metals.

[Patent document 1] Japanese Unexamined Patent Publication No. 2003-149683

### DISCLOSURE OF THE INVENTION

### Problems to be Solved by the Invention

A task of the present invention is to solve the above-mentioned problems and to provide a method for preparing a dispersion liquid comprising liquid crystal-compatible particles and a paste thereof, which is commercially advantageous in, that a dispersion liquid comprising liquid crystal-compatible particles and a uniform liquid crystal-compatible particle paste can be obtained using a method which can easily achieve mass-production.

### Means to Solve the Problems

The task of the present invention is achieved by a method for preparing a dispersion liquid comprising liquid crystal-compatible particles wherein the method comprises mixing together at least one type of liquid crystal molecules, a secondary alcohol represented by the following general formula (1):

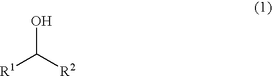

wherein R¹ and R² are the same or different and independently represent a hydrocarbon group optionally having a substituent, or R¹ and R² may be bonded together to form a ring,
   and an organic solvent, and adding to the resultant mixture a solution containing at least one type of metal ions while heating the mixture under reflux to effect a reaction, and a dispersion liquid made thereby. The term “liquid crystal-compatible particles” means particles which can be uniformly dispersed in a liquid crystal material. The wording “to effect a reaction” means to reduce metal ions to a metal. It is presumed that the liquid crystal-compatible particles in the present invention have a structure comprising a central core comprised of a plurality of metal particles formed by reduction of at least one type of metal ions, and liquid crystal molecules surrounding the central core with a certain interaction. The core comprised of a plurality of metal particles may have either a random alloy structure wherein two or more types of metal particles are randomly distributed, or a core-shell structure wherein a shell is comprised of one type of metal particles and a core is comprised of another type of metal particles. Particles comprised of one type of metal particles are referred to as single-component particles, and those comprised of two types of metal particles are referred to as binary particles.

The task of the present invention is also achieved by a uniform liquid crystal-compatible particle paste obtainable from the dispersion comprising liquid crystal-compatible particles obtained by the above method, or a method for preparing the same.

### EFFECT OF THE INVENTION

In the present invention, there can be provided a method for preparing a dispersion liquid comprising liquid crystal-compatible particles and a paste thereof, which is commercially advantageous in that a dispersion liquid comprising liquid crystal-compatible particles and a uniform liquid crystal-compatible particle paste can be obtained using a method which can easily achieve mass-production.

### BRIEF DESCRIPTION OF THE DRAWINGS

FIG. 1

A transmission electron photomicrograph of the liquid crystal-compatible palladium-silver binary nanoparticles prepared by the method in Example 1.

FIG. 2

A transmission electron photomicrograph of the liquid crystal-compatible palladium-silver binary nanoparticles prepared by the method in Comparative Example 1.

FIG. 3

A transmission electron photomicrograph of the liquid crystal-compatible palladium-silver binary nanoparticles prepared by the method in Comparative Example 2.

FIG. 4

A transmission electron photomicrograph of the liquid crystal-compatible palladium-silver binary nanoparticles prepared by the method in Example 2.

FIG. 5

A transmission electron photomicrograph of the liquid crystal-compatible palladium-silver binary nanoparticles prepared by the method in Example 3.

FIG. 6

A transmission electron photomicrograph of the liquid crystal-compatible palladium-silver binary nanoparticles prepared by the method in Example 4.

FIG. 7

A transmission electron photomicrograph of the liquid crystal-compatible palladium-silver binary nanoparticles prepared by the method in Example 5.

FIG. 8

A transmission electron photomicrograph of the liquid crystal-compatible palladium-silver binary nanoparticles prepared by the method in Example 6.

FIG. 9

A transmission electron photomicrograph of the liquid crystal-compatible palladium-silver binary nanoparticles prepared by the method in Example 7.

FIG. 10

A transmission electron photomicrograph of the liquid crystal-compatible palladium-silver binary nanoparticles prepared by the method in Example 8.

FIG. 11

A transmission electron photomicrograph of the liquid crystal-compatible palladium-silver binary nanoparticles prepared by the method in Example 9.

FIG. 12

A transmission electron photomicrograph of the liquid crystal-compatible palladium-silver binary nanoparticles prepared by the method in Example 10.

### BEST MODE FOR CARRYING OUT THE INVENTION

Examples of liquid crystal molecules used in the reaction in the present invention include cyanobiphenyls, such as 4′-n-pentyl-4-cyanobiphenyl and 4′-n-hexyloxy-4-cyanobiphenyl; cyclohexylbenzonitriles, such as 4-(trans-4-n-pentylcyclohexyl)benzonitrile; phenyl esters, such as 4-cyanophenyl 4-butylbenzoate and 4-cyanophenyl 4-heptylbenzoate; carbonates, such as 4-carboxyphenylethyl carbonate and 4-carboxyphenyl-n-butyl carbonate; phenylacetylenes, such as 4-(4-n-pentylphenylethynyl)cyanobenzene and 4-(4-n-pentylphenylethynyl)fluorobenzene; phenylpyrimidines, such as 2-(4-cyanophenyl)-5-n-pentylpyrimidine and 2-(4-cyanophenyl)-5-n-octylpyrimidine; azobenzenes, such as 4,4′-bis(ethoxycarbonyl)azobenzene; azoxybenzenes, such as 4,4′-azoxyanisole and 4,4′-dihexylazoxybenzene; Schiff bases, such as N-(4-methoxybenzylidene)-4-n-butylaniline and N-(4-ethoxybenzylidene)-4-n-butylaniline; benzidines, such as N,N′-bisbenzylidenebenzidine; cholesteryl esters, such as cholesteryl acetate and cholesteryl benzoate; and liquid crystal polymers, such as poly(4-phenylene terephthalamide). These liquid crystal molecules may be used individually or in combination, and, as a mixture of two or more types of liquid crystal molecules, one which is commercially available can be used as it is.

In the reaction in the present invention, it is essential to use a secondary alcohol. When a primary alcohol is used, aggregation of the liquid crystal-compatible particles is accelerated to cause a precipitate, and therefore the primary alcohol cannot be used. The secondary alcohol used in the reaction in the present invention is represented by the general formula (1) above. In the general formula (1), each of R¹ and R² is a hydrocarbon group optionally having a substituent, and examples of hydrocarbon groups include alkyl groups having 1 to 7 carbon atoms, such as a methyl group, an ethyl group, a propyl group, a butyl group, a pentyl group, a hexyl group, and a heptyl group; cycloalkyl groups having 3 to 5 carbon atoms, such as a cyclopropyl group, a cyclobutyl group, and a cyclopentyl group; alkenyl groups having 2 to 5 carbon atoms, such as a vinyl group, an allyl group, a propenyl group, a cyclopropenyl group, a cyclobutenyl group, and a cyclopentenyl group; and alkynyl groups having 2 to 5 carbon atoms, such as an ethynyl group and a propynyl group, and preferred examples include alkyl groups, alkenyl groups, and alkynyl groups, and further preferred examples include alkyl groups and alkynyl groups. These groups also include various isomers.

R¹ and R² may be bonded together to form an unsubstituted ring or a ring having a substituent, and examples of rings formed from R¹ and R² bonded together include cycloalkyl rings having 3 to 6 carbon atoms, such as a cyclopropyl ring, a cyclobutyl ring, a cyclopentyl ring, and a cyclohexyl ring; and ether rings having 2 to 5 carbon atoms, such as an oxirane ring, an oxetane ring, a tetrahydrofuran ring, and a tetrahydropyran ring. These rings also include various isomers.

Each of the hydrocarbon group and the ring formed from R¹ and R² bonded together may have a substituent, and examples of the substituents include substituents formed through a carbon atom, substituents formed through an oxygen atom, and halogen atoms.

Examples of the substituents formed through a carbon atom include alkyl groups having 1 to 3 carbon atoms, such as a methyl group, an ethyl group, and a propyl group; cycloalkyl groups having 3 to 4 carbon atoms, such as a cyclopropyl group and a cyclobutyl group; alkenyl groups having 2 to 3 carbon atoms, such as a vinyl group, an allyl group, a propenyl group, and a cyclopropenyl group; alkynyl groups having 2 to 3 carbon atoms, such as an ethynyl group and a propynyl group; haloalkyl groups having 1 to 4 carbon atoms, such as a trifluoromethyl group; and a cyano group. These groups also include various isomers.

Examples of the substituents formed through an oxygen atom include a hydroxyl group; and alkoxy groups having 1 to 3 carbon atoms, such as a methoxy group, an ethoxy group, and a propoxy group. These groups also include various isomers.

Examples of the halogen atoms include a fluorine atom, a chlorine atom, a bromine atom, and an iodine atom.

In the general formula (1), the sum of the number of carbon atoms of R¹ and the number of carbon atoms of R² is preferably 8 or less, especially preferably 4 or less.

The amount of the secondary alcohol used is preferably 0.1 to 200 g, further preferably 1 to 100 g, relative to 1 g of the liquid crystal molecules. These secondary alcohols may be used individually or in combination.

With respect to the organic solvent used in the reaction in the present invention, there is no particular limitation as long as the solvent does not inhibit the reaction, and examples of the organic solvents include ketones, such as acetone, methyl ethyl ketone, and methyl isobutyl ketone; esters, such as methyl acetate, ethyl acetate, butyl acetate, and methyl propionate; amides, such as N,N-dimethylformamide, N,N-dimethylacetamide, and N-methylpyrrolidone; ureas, such as N,N′-dimethylimidazolidinone; sulfoxides, such as dimethyl sulfoxide; sulfones, such as sulfolane; nitriles, such as acetonitrile and propionitrile; ethers, such as diethyl ether, diisopropyl ether, tetrahydrofuran, and dioxane; aliphatic hydrocarbons, such as hexane, heptane, and cyclohexane; and aromatic hydrocarbons, such as benzene, toluene, and xylene, and preferably a nitrile, ether, or aromatic hydrocarbon is used, and further preferably an ether is used. These solvents may be used individually or in combination.

The amount of the organic solvent used is preferably 10 to 500 ml, further preferably 20 to 200 ml, relative to 1 g of the liquid crystal molecules.

The solution containing metal ions used in the reaction in the present invention means a solution obtained by dissolving a metal salt (a salt consisting of a metal ion and a counter ion) in an organic solvent. The metal ions are, for example, transition metal ions, preferably at least one type of metal ions selected from the group consisting of Au⁺, Au³⁺, Ag⁺, Cu⁺, Cu²⁺, Ru²⁺, Ru³⁺, Ru⁴⁺, Rh⁺, Rh²⁺, Rh³⁺, Pd²⁺, Pd⁴⁺, Os⁴⁺, Ir⁺, Ir³⁺, Ir⁴⁺, Pt²⁺, Pt⁴⁺, Fe²⁺, Fe³⁺, Co²⁺, and Co³⁺, and examples of counter ions include a hydrido ion, a halogen ion, a halogenic acid ion, a perhalogenic acid ion, a carboxylic acid ion which may be substituted, an acetylacetonato ion, a carbonic acid ion, a sulfuric acid ion, a nitric acid ion, a tetrafluoroboric acid ion, and a hexafluorophosphoric acid ion. These metal salts may have coordinated with a neutral ligand (e.g., carbon monoxide, triphenylphosphine, or p-cymene). The amount of the metal ions used is 0.1 micromole to 1 millimole, preferably 0.2 micromole to 0.1 millimole, relative to 0.1 g of the liquid crystal material. A preferred combination of the metal ions is a combination of Pd ions (Pd²⁺) and Ag ions (Ag⁺).

As examples of organic solvents used for dissolving the metal ions, there can be mentioned the above-listed organic solvents used in the reaction in the present invention, and, with respect to the amount of the organic solvent used, there is no particular limitation as long as the metal salt can be completely dissolved in the solvent.

The reaction in the present invention is conducted by, for example, a method which comprises mixing together at least one type of liquid crystal molecules, a secondary alcohol, and an organic solvent, and adding to the resultant mixture a solution containing at least one type of metal ions while heating the mixture under reflux to effect a reaction. With respect to the reflux temperature (reaction temperature), there is no particular limitation, but the temperature is preferably 40 to 100° C., and the reaction pressure may be any one of a certain pressure, atmospheric pressure, and a reduced pressure. When two or more types of metal ions are added in the form of solution, with respect to the way of adding the solution, there is no particular limitation, and the addition is performed by, for example, a way in which solutions respectively containing one type of metal ions are individually prepared and added separately or simultaneously (simultaneous addition or divided addition), or a way in which a single solution containing two or more types of metal ions is preliminarily prepared and added.

A dispersion liquid comprising liquid crystal-compatible particles is obtained by the reaction in the present invention, and a uniform, liquid crystal-compatible particle paste can be obtained by concentrating the dispersion liquid. With respect to the method for concentrating the dispersion liquid, there is no particular limitation, but it is preferred that the concentration is performed under a reduced pressure at 20 to 100° C. The liquid crystal-compatible particles in the dispersion liquid or paste of the present invention preferably have a central metal core diameter of 1 to 100 nm, especially preferably 2 to 10 nm.

### EXAMPLES

Hereinbelow, the present invention will be described in more detail with reference to the following Examples, which should not be construed as limiting the scope of the present invention.

### Example 1

### Preparation of Dispersion Liquid and Paste Comprising Liquid Crystal-Compatible Palladium-Silver Binary Nanoparticles

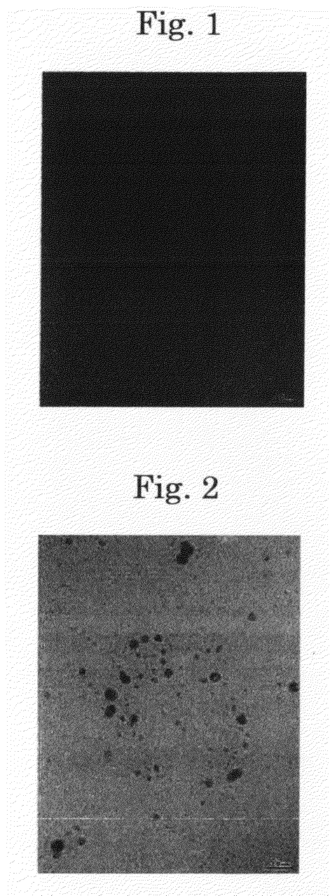

Into a vessel made of glass having an agitator, a thermometer, a reflux condenser, and a dropping funnel, and having an inner capacity of 100 ml were placed 0.33 g (1.32 mmol) of 4′-n-pentyl-4-cyanobiphenyl, 36.7 ml of tetrahydrofuran, and 10 ml of 2-propanol, and the resultant mixture was heated under reflux (65 to 75° C.) while stirring. Then, 1.65 ml (0.0165 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 1.65 ml (0.0165 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter was 2 to 5 nm (FIG. 1). Further, the obtained dispersion liquid comprising liquid crystal-compatible palladium-silver binary nanoparticles was concentrated under a reduced pressure to obtain 0.34 g of a blackish brown, uniform liquid crystal-compatible palladium-silver binary nanoparticle paste.

### Comparative Example 1

### Preparation of Dispersion Liquid and Paste Comprising Liquid Crystal-Compatible Palladium-Silver Binary Nanoparticles

Into a Schlenk tube made of quartz were placed 0.33 g (1.32 mmol) of 4′-n-pentyl-4-cyanobiphenyl, 36.7 ml of tetrahydrofuran, and 10 ml of 2-propanol, and, while stirring the resultant mixture at room temperature, 1.65 ml (0.0165 mmol, in terms of a silver atom) of a 0.01 mol/l tetrahydrofuran solution of silver perchlorate and 1.65 ml (0.0165 mmol, in terms of a palladium atom) of a 0.01 mol/l tetrahydrofuran solution of palladium acetate were successively added to the mixture, and the resultant mixture was freeze-deaerated. In the reaction system of an argon atmosphere, the mixture was irradiated with ultraviolet light using a 500 W ultrahigh-pressure mercury lamp (USHIO UI-502Q) for two hours to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were non-uniform with the central metal core diameter of 2 to 10 nm (FIG. 2). Further, the obtained dispersion liquid comprising liquid crystal-compatible palladium-silver binary nanoparticles was concentrated under a reduced pressure to obtain 0.34 g of a blackish brown liquid crystal-compatible palladium-silver binary nanoparticle paste. A small amount of precipitates were found in the paste.

### Comparative Example 2

### Preparation of Dispersion Liquid and Paste Comprising Liquid Crystal-Compatible Palladium-Silver Binary Nanoparticles

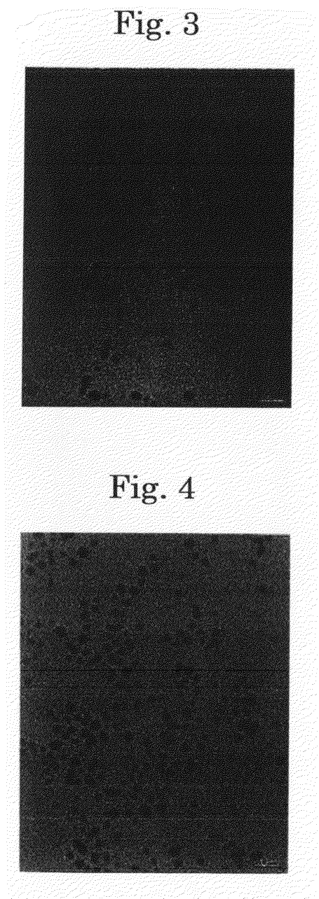

Into a vessel made of glass having an agitator, a thermometer, a reflux condenser, and a dropping funnel, and having an inner capacity of 100 ml were placed 0.33 g (1.32 mmol) of 4′-n-pentyl-4-cyanobiphenyl, 36.7 ml of tetrahydrofuran, and 10 ml of 2-propanol, and, while stirring the resultant mixture at room temperature, 1.65 ml (0.0165 mmol, in terms of a silver atom) of a 0.01 mol/l tetrahydrofuran solution of silver trifluoroacetate and 1.65 ml (0.0165 mmol, in terms of a palladium atom) of a 0.01 mol/l tetrahydrofuran solution of palladium acetate were successively added to the mixture. Then, the resultant mixture was heated under reflux (65 to 75° C.) while stirring to effect a reaction for one hour. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were non-uniform with the central metal core diameter of 2 to 10 nm (FIG. 3). Further, the obtained dispersion liquid comprising liquid crystal-compatible palladium-silver binary nanoparticles was concentrated under a reduced pressure to obtain 0.34 g of a blackish brown liquid crystal-compatible palladium-silver binary nanoparticle paste. A small amount of precipitates were found in the paste.

### Example 2

### Preparation of Dispersion Liquid and Paste Comprising Liquid Crystal-Compatible Palladium-Silver Binary Nanoparticles

Into a jacketed vessel made of glass having an agitator, a thermometer, a reflux condenser, and a syringe pump, and having an inner capacity of 500 ml were placed at room temperature 1.32 g (5.29 mmol) of 4′-n-pentyl-4-cyanobiphenyl, 146.8 ml of tetrahydrofuran, and 40 ml of 2-propanol, and the resultant mixture was heated under reflux (65 to 75° C.) while stirring. Then, 2.64 ml (0.0264 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 10.56 ml (0.1056 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 200 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 5 nm (FIG. 4). Further, the obtained dispersion liquid comprising liquid crystal-compatible palladium-silver binary nanoparticles was concentrated under a reduced pressure to obtain 1.35 g of a blackish brown, uniform liquid crystal-compatible palladium-silver binary nanoparticle paste.

### Example 3

### Preparation of Dispersion Liquid and Paste Comprising Liquid Crystal-Compatible Palladium-Silver Binary Nanoparticles

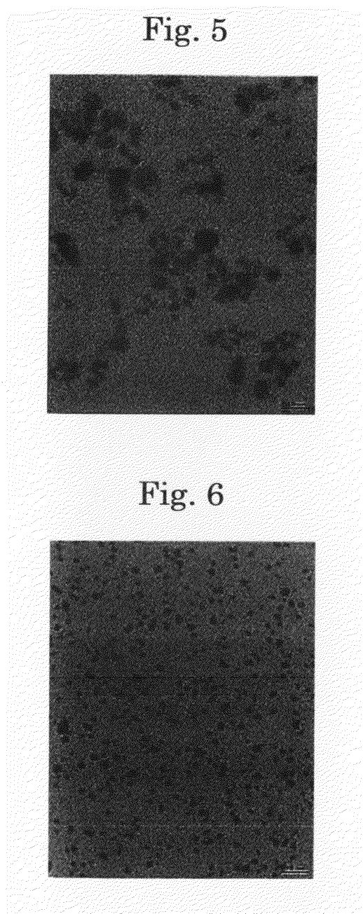

Into a vessel made of glass having an agitator, a thermometer, a reflux condenser, and a dropping funnel, and having an inner capacity of 100 ml were placed 0.33 g (1.32 mmol) of 4′-n-pentyl-4-cyanobiphenyl, 36.7 ml of tetrahydrofuran, and 10 ml of 2-propanol, and the resultant mixture was heated under reflux (65 to 75° C.) while stirring. Then, 2.97 ml (0.0297 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 0.33 ml (0.0033 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 5 nm (FIG. 5). Further, the obtained liquid crystal-compatible palladium-silver binary nanoparticle dispersion liquid was concentrated under a reduced pressure to obtain 0.34 g of a blackish brown, uniform liquid crystal-compatible palladium-silver binary nanoparticle paste.

### Example 4

### Preparation of Dispersion Liquid and Paste Comprising Liquid Crystal-Compatible Palladium-Silver Binary Nanoparticles

Into a vessel made of glass having an agitator, a thermometer, a reflux condenser, and a dropping funnel, and having an inner capacity of 100 ml were placed 0.34 g (1.32 mmol) of 4-(trans-4-n-pentylcyclohexyl)benzonitrile, 36.7 ml of tetrahydrofuran, and 10 ml of 2-propanol, and the resultant mixture was heated under reflux (65 to 75° C.) while stirring. Then, 1.65 ml (0.0165 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 1.65 ml (0.0165 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 5 nm (FIG. 6). Further, the obtained liquid crystal-compatible palladium-silver binary nanoparticle dispersion liquid was concentrated under a reduced pressure to obtain 0.35 g of a blackish brown, uniform liquid crystal-compatible palladium-silver binary nanoparticle paste.

### Example 5

### Preparation of Dispersion Liquid and Paste Comprising Liquid Crystal-Compatible Palladium-Silver Binary Nanoparticles

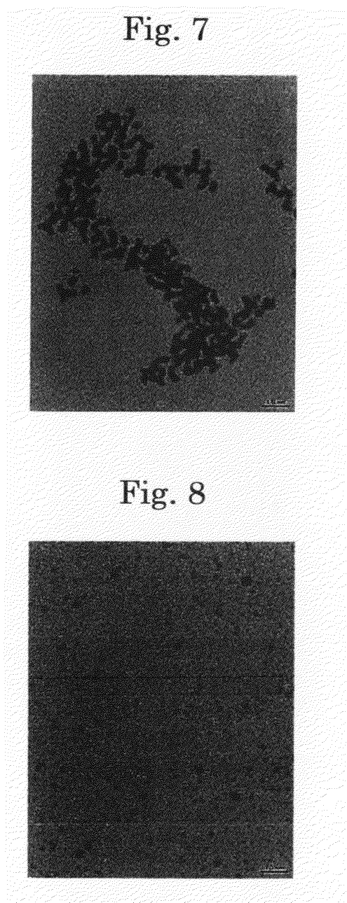

Into a vessel made of glass having an agitator, a thermometer, a reflux condenser, and a dropping funnel, and having an inner capacity of 100 ml were placed 0.34 g (1.32 mmol) of 4-(trans-4-n-pentylcyclohexyl)benzonitrile, 36.7 ml of tetrahydrofuran, and 10 ml of 2-propanol, and the resultant mixture was heated under reflux (65 to 75° C.) while stirring. Then, 0.66 ml (0.0066 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 2.64 ml (0.0264 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 5 nm (FIG. 7). Further, the obtained liquid crystal-compatible palladium-silver binary nanoparticle dispersion liquid was concentrated under a reduced pressure to obtain 0.35 g of a blackish brown, uniform liquid crystal-compatible palladium-silver binary nanoparticle paste.

### Example 6

### Preparation of Dispersion Liquid and Paste Comprising Liquid Crystal-Compatible Palladium-Silver Binary Nanoparticles

Into a vessel made of glass having an agitator, a thermometer, a reflux condenser, and a dropping funnel, and having an inner capacity of 100 ml were placed 0.33 g (1.32 mmol) of 4′-n-pentyl-4-cyanobiphenyl, 36.7 ml of tetrahydrofuran, and 10 ml of 3-butyn-2-ol, and the resultant mixture was heated under reflux (65 to 75° C.) while stirring. Then, 1.65 ml (0.0165 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 1.65 ml (0.0165 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 6 nm (FIG. 8). Further, the obtained liquid crystal-compatible palladium-silver binary nanoparticle dispersion liquid was concentrated under a reduced pressure to obtain 0.35 g of a blackish brown, uniform liquid crystal-compatible palladium-silver binary nanoparticle paste.

### Example 7

### Preparation of Dispersion Liquid and Paste Comprising Liquid Crystal-Compatible Palladium-Silver Binary Nanoparticles

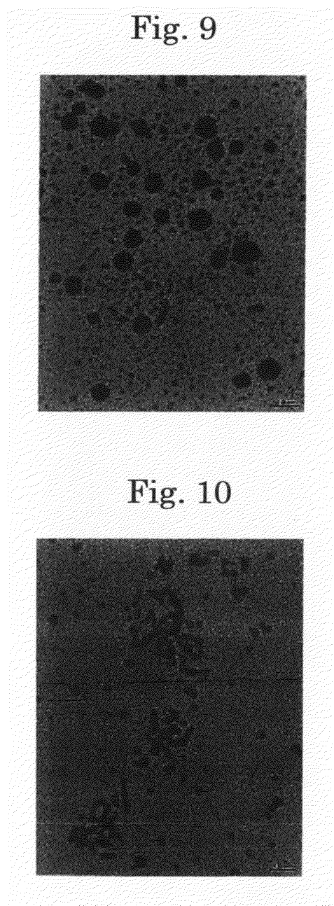

Into a vessel made of glass having an agitator, a thermometer, a reflux condenser, and a dropping funnel, and having an inner capacity of 100 ml were placed 0.33 g (1.32 mmol) of 4′-n-pentyl-4-cyanobiphenyl, 36.7 ml of tetrahydrofuran, and 10 ml of tetrahydrofuran-3-ol, and the resultant mixture was heated under reflux (65 to 75° C.) while stirring. Then, 1.65 ml (0.0165 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 1.65 ml (0.0165 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 8 nm (FIG. 9). Further, the obtained liquid crystal-compatible palladium-silver binary nanoparticle dispersion liquid was concentrated under a reduced pressure to obtain 0.35 g of a blackish brown, uniform liquid crystal-compatible palladium-silver binary nanoparticle paste.

### Example 8

### Preparation of Dispersion Liquid and Paste Comprising Liquid Crystal-Compatible Palladium-Silver Binary Nanoparticles

Into a vessel made of glass having an agitator, a thermometer, a reflux condenser, and a dropping funnel, and having an inner capacity of 100 ml were placed 0.16 g (0.66 mmol) of 4′-n-pentyl-4-cyanobiphenyl, 0.17 g (0.66 mmol) of 4-(trans-4-n-pentylcyclohexyl)benzonitrile, 36.7 ml of tetrahydrofuran, and 10 ml of 2-propanol, and the resultant mixture was heated under reflux (65 to 75° C.) while stirring. Then, 1.65 ml (0.0165 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 1.65 ml (0.0165 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 6 nm (FIG. 10). Further, the obtained liquid crystal-compatible palladium-silver binary nanoparticle dispersion liquid was concentrated under a reduced pressure to obtain 0.35 g of a blackish brown, uniform liquid crystal-compatible palladium-silver binary nanoparticle paste.

### Example 9

### Preparation of Dispersion Liquid and Paste Comprising Liquid Crystal-Compatible Palladium-Silver Binary Nanoparticles

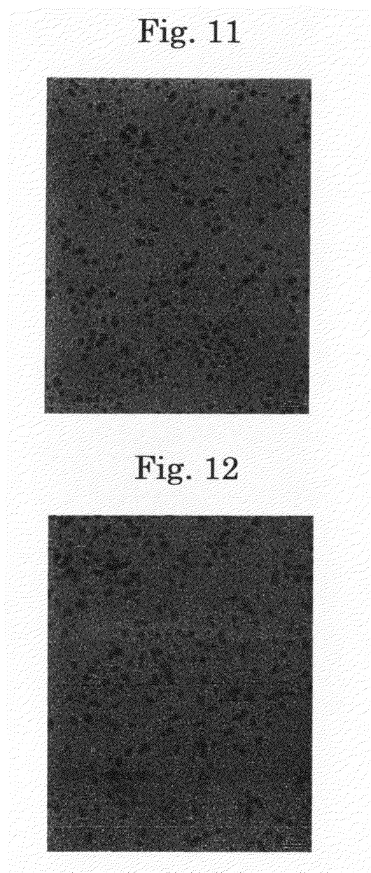

Into a vessel made of glass having an agitator, a thermometer, a reflux condenser, and a dropping funnel, and having an inner capacity of 100 ml were placed 0.20 g of a mixture of several types of liquid crystal molecules (LC3, manufactured by Dainippon Ink & Chemicals Incorporated), 36.0 ml of tetrahydrofuran, and 10 ml of 2-propanol, and the resultant mixture was heated under reflux (65 to 75° C.) while stirring. Then, 2.0 ml (0.020 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 2.0 ml (0.020 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 4 nm (FIG. 11). Further, the obtained liquid crystal-compatible palladium-silver binary nanoparticle dispersion liquid was concentrated under a reduced pressure to obtain 0.22 g of a blackish brown, uniform liquid crystal-compatible palladium-silver binary nanoparticle paste.

### Example 10

### Preparation of Dispersion Liquid and Paste Comprising Liquid Crystal-Compatible Palladium-Silver Binary Nanoparticles

Into a vessel made of glass having an agitator, a thermometer, a reflux condenser, and a dropping funnel, and having an inner capacity of 100 ml were placed 0.20 g of a mixture of several types of liquid crystal molecules (LC4, manufactured by Dainippon Ink & Chemicals Incorporated), 36.0 ml of tetrahydrofuran, and 10 ml of 2-propanol, and the resultant mixture was heated under reflux (65 to 75° C.) while stirring. Then, 2.0 ml (0.020 mmol, in terms of a silver atom) of a 0.01 mol/l tetrahydrofuran solution of silver trifluoroacetate was slowly added dropwise to the mixture to effect a reaction at the same temperature for 15 minutes while stirring, and then 2.0 ml (0.020 mmol, in terms of a palladium atom) of a 0.01 mol/l tetrahydrofuran solution of palladium acetate was slowly added dropwise to the mixture to effect a reaction at the same temperature for another 15 minutes while stirring. After completion of the reaction, the resultant reaction mixture was cooled to room temperature to obtain 50 ml of a blackish brown, uniform liquid crystal-compatible palladium-silver binary nanoparticle dispersion liquid. The dispersion liquid obtained was examined under a transmission electron microscope, and, as a result, it was found that the liquid crystal-compatible palladium-silver binary nanoparticles were uniform with the central metal core diameter of 2 to 4 nm (FIG. 12). Further, the obtained liquid crystal-compatible palladium-silver binary nanoparticle dispersion liquid was concentrated under a reduced pressure to obtain 0.22 g of a blackish brown, uniform liquid crystal-compatible palladium-silver binary nanoparticle paste.

### INDUSTRIAL APPLICABILITY

The present invention is directed to a dispersion liquid comprising liquid crystal-compatible particles, a paste obtained therefrom, and a method for preparing the same. The liquid crystal-compatible particle paste is useful as an additive material for, e.g., liquid crystal display to improve the response time or lower the driving voltage for liquid crystal.

1. A method for preparing a dispersion liquid comprising liquid crystal-compatible particles,
the method comprising mixing together at least one type of liquid crystal molecules, a secondary alcohol represented by the following general formula (1): 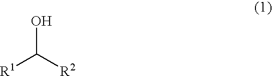
wherein R¹ and R² are the same or different and independently represent a hydrocarbon group optionally having a substituent, or R¹ and R² may be bonded together to form a ring,
and an organic solvent, and adding to the resultant mixture a solution containing at least one type of metal ions while heating the mixture under reflux to effect a reaction.

2. The method according to claim 1, wherein the reflux temperature is 40 to 100° C.

3. The method according to claim 1, wherein the metal ions are at least one type of metal ions selected from the group consisting of Au⁺, Au³⁺, Ag⁺, Cu⁺, Cu²⁺, Ru²⁺, Ru³⁺, Ru⁴⁺, Rh⁺, Rh²⁺, Rh³⁺, Pd²⁺, Pd⁴⁺, Os⁴⁺, Ir⁺, Ir³⁺, Ir⁴⁺, Pt²⁺, Pt⁴⁺, Fe²⁺, Fe³⁺, Co²⁺, and Co³⁺.

4. The method according to claim 1, wherein the metal ions are two types of metal ions Ag⁺ and Pd²⁺.

5. The method according to claim 1, wherein the sum of number of carbon atoms of both R¹ and R² in the general formula (1) is 4 or less.

6. The method according to claim 1, wherein the secondary alcohol is 2-propanol.

7. A dispersion liquid comprising liquid crystal-compatible particles obtainable by the method according to claim 1.

8. The dispersion liquid according to claim 7, wherein the liquid crystal-compatible particles have a central metal core diameter of 1 to 100 nm.

9. The dispersion liquid according to claim 8, wherein the liquid crystal-compatible particles have a central metal core diameter of 2 to 10 nm.

10. The dispersion liquid according to claim 7, wherein the liquid crystal-compatible particles are liquid crystal-compatible palladium-silver binary nanoparticles.

11. A liquid crystal-compatible particle paste obtainable from the dispersion liquid comprising liquid crystal-compatible particles obtained by the method according to claim 1.

12. A method for preparing a liquid crystal-compatible particle paste according to claim 11, the method comprising concentrating a dispersion liquid comprising liquid crystal-compatible particles to obtain the liquid crystal-compatible particle paste.
